(19) United States
(12) Patent Application Publication
(10) Pub. No.: US 2021/0060704 A1
(43) Pub. Date: Mar. 4, 2021

(54) METHOD FOR PRODUCING AT LEAST ONE PATTERNED DESIGN COMPRISING A PLURALITY OF PATTERN ELEMENTS BY MEANS OF A LASER

(71) Applicant: JENOPTIK Automatisierungstechnik GmbH, Jena (DE)

(72) Inventors: Oliver KUHL, Jena (DE); Andreas BODE-MOSIG, Jena (DE); Frank SEIDEL, Thalbuergel (DE); Juergen HIELSCHER, Jena (DE)

(73) Assignee: JENOPTIK Automatisierungstechnik GmbH, Jena (DE)

(21) Appl. No.: 17/012,707

(22) Filed: Sep. 4, 2020

(30) Foreign Application Priority Data
Sep. 4, 2019 (DE) 10 2019 123 654.1

(51) Int. Cl. B23K 26/359; B05D 3/06; B23K 26/00; B23K 26/082

(52) U.S. Cl. CPC B23K 26/359; B05D 3/06; B29L 2031/3005; B23K 26/082; B23K 26/0006

(57) ABSTRACT

A method for producing at least one patterned design having a plurality of pattern elements via a laser in a component that is at least partially transparent and is coated on a first surface. The component is coated on a first surface with at least one layer. The coated first surface of the component is surveyed with first co-ordinated. At least one patterned design is created with second coordinates. The second coordinates of the at least one patterned design are transformed into third coordinates. The coated first surface is irradiated with laser radiation via control coordinates. The laser radiation is measured on a second surface and the laser radiation received is compared via the sensor system with a reference value. The laser radiation is switched off when the reference value is reached.

This nonprovisional application claims priority under 35 U.S.C. § 119(a) to German Patent Application No. 10 2019 123 654.1, which was filed in Germany on Sep. 4, 2019, and which is herein incorporated by reference.

### BACKGROUND OF THE INVENTION

### Field of the Invention

The present invention relates to a method for producing at least one patterned design comprising a plurality of pattern elements by means of a laser in a component that is at least partially transparent and is coated on a first surface.

### Description of the Background Art

In the prior art in this context, the document DE 10 2010 032 190 A1 is known, which discloses a lighting unit for a motor vehicle having a number of illuminants and a radiation-transmitting body arranged in the emission region thereof. The surface of said radiation-transmitting body is provided with a decorative coating on the side of the light exit, wherein the coating is provided a number of openings in the manner of a perforation, through which openings the light exiting from the radiation-transmitting body can pass substantially without being impaired. Obtaining the perforation also by subsequently removing small areas from the whole-area coating is described.

The subsequent removal of layers for a planned back-lighting requires a high precision, as even the smallest geometric deviations become optically visible due to the back-lighting of the ablated surfaces in periodic patterns. This likewise applies to deviations in the transparency.

Production-dictated tolerances of the radiation-transmitting bodies and the applied layers are to be considered in the method of the subsequent removal.

These requirements in their complexity require a controlled process, which takes place according to the invention by means of laser processing.

### SUMMARY OF THE INVENTION

It is therefore an object of the present invention to provide a description of a method for producing at least one patterned design comprising a plurality of pattern elements by means of a laser in a component that is at least partially transparent and is coated on a first surface, comprising the following steps: providing the component; coating the component on the first surface with at least one layer; surveying the coated first surface of the component with first coordinates; creating the at least one patterned design with second coordinates; transforming the second coordinates of the at least one patterned design into third coordinates by means of the first coordinates of the coated first surface of the component; transforming the third coordinates into control coordinates of the laser and/or of the component; irradiating the coated first surface with laser radiation of the laser by means of the control coordinates; measuring the laser radiation on a second surface of the component, which second surface is opposite the first surface, by means of a sensor system; comparing the laser radiation received by way of the sensor system with a reference value; and switching off the laser radiation when the reference value is reached.

A major advantage of the invention is the possibility to produce one or more patterned designs of any desired defined size, geometry and transparency on defined positions of a component that is at least partially transparent and is coated on a first surface.

The providing step can comprise a positioning of the component in a fixing device. The fixing device can, for example, be formed having markers, such that the component can be positioned in the fixing device positionally-accurately and in a defined relative location with regard to the laser radiation.

A robot module, for example, a 6-axis robot module, can engage on the fixing device and can move the component relative to the processing laser radiation in three-dimensional space.

The coating step can comprise coating with a primer layer and a top layer. The primer layer can, for example, be formed as a primer, which should improve the adhesion between a carrier and a further layer. The top layer can, for example, be formed as a lacquer layer, as is normally used in the lacquering of vehicles. In this exemplary embodiment, the component thus comprises at least one carrier, a primer layer and a top layer.

The 3D-shaped component can be surveyed by means of a 3D camera, which functions, for example, in accordance with the stereo principle or is formed as a triangulation measurement system. The surveyed 3D contour is present as a dataset with first coordinates (x1n, y1n, z1n), e.g. in CAD format.

The laser can comprise a scanner, in particular a 3-axis galvanometer scanner, which moves the laser radiation relative to the component in three-dimensional space. The third coordinates are transformed into control coordinates of the scanner.

The laser can be formed a short-pulse laser, the laser pulses of which can have a length of, for example, 1-10 ps and a pulse repetition frequency of 10-100 kHz. The reduced energy input ensures that adjacent regions of the individual pattern elements are not damaged.

The sensor system can comprise an array made of a plurality of photoelectric sensors (sensor system array). The arrangement of the sensors in the array is adapted to the patterned design/s to be produced. This enables a quick procedure in the production of the at least one patterned design, as a relative movement of the sensor system with regard to the laser radiation and/or to the component can be omitted.

The production of the pattern elements takes place in series or in a plurality of cycles. In serial production, each pattern element is impinged on by the laser radiation respectively until the reference value is reached.

In production in a plurality of cycles, the pattern elements are subjected to laser treatment in a plurality of cycles along the patterned design/s to be produced. In this way, each pattern element is impinged on by laser radiation of equal energy in each cycle. The pattern elements which have reached the reference value are detected by means of the sensor system. The pattern elements which have reached the reference value are skipped by the laser controller in the next cycle and are not subjected to laser treatment any more. The cycles are repeated until all pattern elements have reached the reference value.

The value measured by means of the sensor system can be compared with a reference value ascertained in advance. In order to reach a uniform transparency of all patterned designs, all pattern elements are processed with a reference value determined in advance.

When the reference value defined in advance is reached, the laser radiation is switched off.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a component in side view with a pattern element;

FIG. 2 shows a component in top view with a pattern element and a patterned design comprising a plurality of pattern elements;

FIG. 3 shows a component in top view with a plurality of individual patterned designs; and

FIG. 4 shows a device for carrying out the method according to the invention.

### DETAILED DESCRIPTION

In the following description of favourable exemplary embodiments of the present invention, the same or similar reference signs are used for the elements that are illustrated in the different figures and have a similar effect, wherein a repeated description of these elements is omitted.

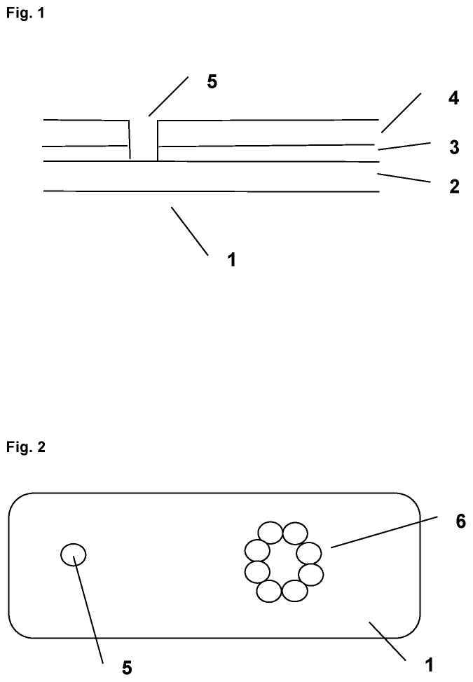

FIG. 1 shows a component 1 in side view with a pattern element 5.

Exterior components from the vehicle industry can be considered as components 1. Here, this involves 3D-shaped, transparent plastic parts such as, for example, spoilers or bumpers. Polycarbonate (PC) or acrylonitrile-butadiene-styrene (ABS), for example, are used as materials for a carrier 2. The carrier 2 is coated. The coating usually takes place with a primer layer 3 (primer) and a decorative lacquer layer 4.

Furthermore, FIG. 1 shows a first pattern element 5, which is characterized by the local removal of both layers 3,4 down to the carrier 2.

FIG. 2 shows in plan view how individual pattern elements 5 are combined to form a patterned design 6, for example a circle.

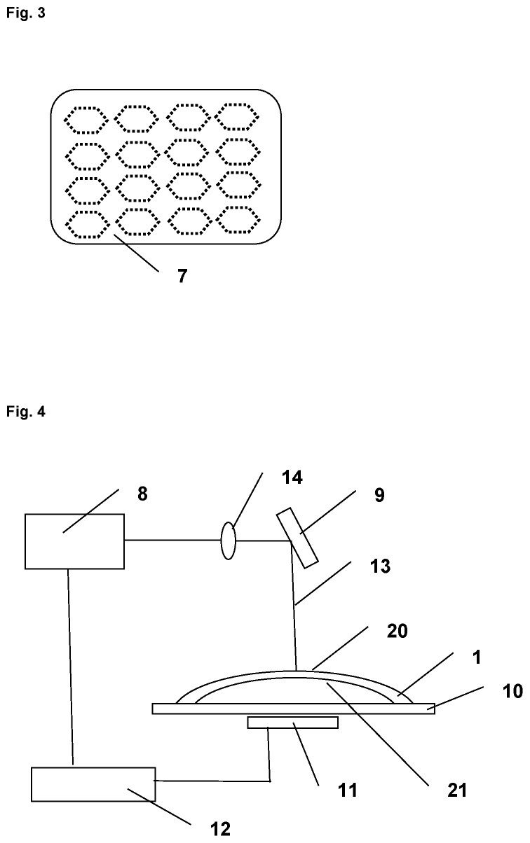

A juxtaposition of patterned designs 6 within a surface 7 is shown by way of example in FIG. 3.

The method according to the invention requires a relative movement between component 1 and the processing laser radiation 13. This is realizable, for example, by a movement of the laser 8 and/or by a movement of the component 1 and/or by a movement of the laser radiation 13. The defined movement of the laser radiation 13 generally takes place by means of a scanner 9. The component 1 in a fixing device 10 can be moved in front of the laser radiation 13 by means of a robot module (not shown). A combination of the three movements is also possible. The further description of the method discloses the use of a scanner 9 in exemplary fashion. Thus, in this exemplary embodiment, both the laser 8 and the component 1 are arranged in non-movable fashion.

FIG. 4 shows a device for carrying out the method according to the invention.

The provided component 1 is coated on a first surface 20 with at least one layer 3,4. The exterior components described in the example are usually coated with a primer coat 3 (primer) and a decorative lacquer layer 4.

In the further processing, the component 1 is mounted in a fixing device 10. For a positionally-accurate location of the component 1 in the fixing device 10 and a defined relative location of the component 1 with regard to the processing laser radiation 13, at least one marker is to be introduced. This marker can be applied to the fixing device 10 and/or to the component 1 and is used as a reference point for the following surveying and processing. The reference point can be formed as a co-ordinate origin of a three-dimensional co-ordinate system x-y-z.

The robot module grips the fixing device 10 within which the component 1 is fixed, in order to position the component 1 by means of the robot module.

Preferably, the whole, three-dimensionally-shaped component 1 is surveyed. It is essential to the invention, though, that at least the areas on which the patterned designs 6 should be produced are surveyed. The surveying takes place in three dimensions, preferably by means of a 3D camera. As a result, first coordinates (x1n, y1 n, z1n) are present as a dataset, for example in CAD format.

The patterned designs 6 to be produced comprise individual pattern elements 5 which are variable in their size, geometry and positioning relative to one another. The points illustrated in the figures stand as an example of any desired geometric shapes which are focusable by means of a laser optical unit 14.

The patterned designs 6 to be produced are created with a dataset of second coordinates (x2n, y2n, z2n), preferably in the same format as the first coordinates (x1n, y1n, z1n), which are present from the surveying.

By means of particular mapping software, the second coordinates (x2n, y2n, z2n) of the patterned designs 6 to be created are transformed by means of the first coordinates (x1n, y1 n, z1n) of the coated first surface 20 of the component 1. As a result of this transformation, third coordinates (x3n, y3n, z3n) are present, which represent a mapping of the patterned designs 6 to be created onto the exactly surveyed surface 20 of the actual component 1. The third coordinates (x3n, y3n, z3n) exactly represent the positions on the component 1 on which the processing by means of the laser radiation 13 should take place.

These third coordinates (x3n, y3n, z3n) can be transformed into control coordinates of the laser 8 and/or of the scanner 9 and/or of the component 1.

The control coordinates ensure that the laser radiation 13 is incident on the component 1 at the correct position. By means of a suitable laser optical unit 14, size and geometry of the pattern elements 5 can be modified.

The method is thus extremely flexible and enables in this way the introduction of any desired patterned designs 6 in a wide variety geometries.

It is necessary to keep the energy input of the laser radiation 13 as low as possible. This ensures that the material surrounding the pattern elements 5 is not damaged. On the basis of experience, a short-pulse laser is used for this, preferably with laser pulses of a length of 1-10 ps and a pulse repetition frequency of 10-100 kHz.

A further important aspect of the described method is the setting of a defined transparency across all pattern elements 5. This is implemented by means of a sensor system 11.

The sensor system 11, usually in accordance with the photoelectric principle, receives the laser radiation 13 on a second surface 21 of the transparent component 1, said second surface being opposite the first surface 20, and thus detects the transparent proportion of the laser radiation 13 that passes through the carrier 2.

In preceding experiments, reference values which can be used for controlling the laser radiation 13 are determined.

When the reference value, ascertained in advance and stored, and thus the desired transparency of the component 1, is reached, a signal passes from the sensor system 11 to the laser controller 12, which controller switches off the laser radiation 13.

This can take place in series, i.e. each pattern element 5 is subjected to laser treatment until the reference value is reached. Afterwards, a controlled relative movement between laser radiation 13 and component 1 takes place and the next pattern element 5 of the patterned design 6 to be produced is produced in the same way.

Furthermore, there is the possibility to lase the pattern elements 5 in a plurality of cycles along the patterned design/s 6 to be produced. In this way, each pattern element 5 is impinged on by laser radiation 13 of equal energy in each cycle. The pattern elements 5 which have reached the reference value are detected by means of the sensor system 11. The pattern elements 5 which have reached the reference value are skipped by the laser controller 12 in the next cycle and are not subjected to laser treatment any more. The cycles are repeated until all pattern elements 5 of the patterned design/s 6 have reached the reference value.

The sensor system 11 comprises at least one photoelectric sensor. It must be ensured that the sensor system 11 is located in the optical axis of the laser radiation 13 at the point in time of the processing and the measuring of the transparent proportion of the laser radiation 13 that passes through the component 1.

The positioning of the sensor system 11 into the optical axis of the laser radiation 13 can be implemented by a relative movement between laser radiation 13 and sensor system 11 or between component 1 and sensor system 11.

Furthermore, a sensor system 11 array can be used, which includes a defined arrangement of a plurality of sensors. An otherwise necessary relative movement can be obviated by an arrangement of sensors in an array, said arrangement being adapted to the at least one patterned design 6 to be created.

The use of a sensor system array is suitable in particular for the production of the patterned designs 6 in a plurality of cycles.

With the method according to the invention, it is possible to set a homogeneous transparency across all pattern elements 5 by means of a reference value set in advance. A subsequent quality control is not necessary, as the control by means of a reference value takes place online in the production process.

Furthermore, to obtain specific effects with the method according to the invention it is also possible to realize defined gradations in the transparency of the pattern elements 5 and/or of the patterned designs 6 on the component 1 by varying the reference value.

The method according to the invention is thus suitable for producing patterned designs 6 of any desired defined size, geometry and transparency on defined positions of a component 1 that is at least partially transparent and is coated on a first surface 20.

The exemplary embodiments described, and shown in the figures, are only selected by way of example. Different exemplary embodiments can be combined with one another completely or in regard to individual features. Moreover, an exemplary embodiment can be supplemented by features of a further exemplary embodiment.

Furthermore, method steps according to the invention can be performed repeatedly and in a different order from that described.

If an exemplary embodiment comprises an “and/or” link between a first feature and a second feature, then this should be interpreted such that the exemplary embodiment comprises both the first feature and the second feature in accordance with one embodiment and either only the first feature or only the second feature in accordance with a further embodiment.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for producing at least one patterned design comprising a plurality of pattern elements via a laser in a component that is at least partially transparent and is coated on a first surface, the method comprising:
providing the component;
coating the component on a first surface with at least one layer;
surveying the coated first surface of the component with first coordinates;
creating the at least one patterned design with second coordinates;
transforming the second coordinates of the at least one patterned design into third coordinates via the first coordinates of the coated first surface of the component;
transforming the third coordinates into control coordinates of the laser and/or of the component;
irradiating the coated first surface with laser radiation of the laser via the control coordinates;
measuring the laser radiation on a second surface of the component, which second surface is opposite the first surface, via a sensor system;
comparing the laser radiation received by way of the sensor system with a reference value; and
switching off the laser radiation when the reference value is reached.

2. The method according to claim 1, wherein the providing step comprises a positioning of the component in a fixing device.

3. The method according to claim 2, wherein a robot module grips the fixing device in order to position the component.

4. The method according to claim 1, wherein the coating step comprises coating with a primer layer and a top layer.

5. The method according to claim 1, wherein the surveying step comprises surveying via a 3D camera.

6. The method according to claim 1, wherein the laser comprises a scanner and the step of transforming the third coordinates into control coordinates of the scanner takes place.

7. The method according to claim 1, wherein the laser is formed as a short-pulse laser.

8. The method according to claim 1, wherein the sensor system is formed as a sensor system array adapted to the at least one patterned design to be produced.

9. The method according to claim 1, wherein the production of the pattern elements takes place in series or in a plurality of cycles.

10. The method according to claim 1, wherein all pattern elements are processed with a reference value determined in advance.
